(19) United States
(12) Patent Application Publication
(10) Pub. No.: US 2013/0054397 A1
(43) Pub. Date: Feb. 28, 2013

(54) STORE SYSTEM AND METHOD

(71) Applicants: Shinji Nakatake, Shizuoka-ken (JP); Hidehiro Naito, Shizuoka-ken (JP); Hiroyuki Ueda, Shizuoka-ken (JP); Masato Watabe, Shizuoka-ken (JP); Masahide Ogawa, Shizuoka-ken (JP)

(72) Inventors: Shinji Nakatake, Shizuoka-ken (JP); Hidehiro Naito, Shizuoka-ken (JP); Hiroyuki Ueda, Shizuoka-ken (JP); Masato Watabe, Shizuoka-ken (JP); Masahide Ogawa, Shizuoka-ken (JP)

(73) Assignee: TOSHIBA TEC KABUSHIKI KAISHA, Tokyo (JP)

(21) Appl. No.: 13/571,610

(22) Filed: Aug. 10, 2012

(30) Foreign Application Priority Data
Aug. 31, 2011 (JP) 2011-189712

(51) Int. Cl. G06Q 20/20

(52) U.S. Cl. 705/23

(57) ABSTRACT

A store system comprises an image output section configured to output an image captured by an image capturing unit, an object recognition section configured to recognize a specific object by reading the characteristic quantity of the output image and a reporting section configured to report that an object other than a commodity subjected to sales registration is recognized in the condition that the recognized object is the object other than the commodity included in a commodity file storing information for the sales registration.

### CROSS-REFERENCE TO RELATED APPLICATION

This application is based upon and claims the benefit of priority from Japanese Patent Application No. 2011-189712, filed Aug. 31, 2011, the entire contents of which are incorporated herein by reference.

### FIELD

Embodiments described herein relate to a store system and a method.

### BACKGROUND

Formerly, one store system is utilized in a store such as a western-style pastry store, a doughnut store and the like; a tray is shot by a shooting camera; and tableware in the tray is recognized according to a captured image, so as to carryout the registration and the check computation of a commodity contained in the tableware.

### BRIEF DESCRIPTION OF THE DRAWINGS

FIG. 1 is a perspective drawing showing a settlement system of an embodiment;

FIG. 2 is a block diagram showing hardware compositions of a POS terminal and a commodity reading apparatus;

FIG. 3 is a conceptual graph exemplifying a data composition of a PLU file;

FIG. 4 is a conceptual graph exemplifying a data composition of a reported target file;

FIG. 5 is a block diagram showing a function composition of a CPU;

FIG. 6 is a flow chart showing an example of the processing actions of the settlement system of the embodiment;

FIG. 7 is a conceptual graph showing an example of a reading region of a reading window;

FIG. 8 is a conceptual graph exemplifying a condition that an object other than a commodity is recognized;

FIG. 9 is an explanatory drawing schematically showing a concrete example of processing;

FIG. 10 is a conceptual graph exemplifying the condition that the object other than the commodity is recognized; and

FIG. 11 is a conceptual graph showing a display example of a display and a customer-oriented display.

### DETAILED DESCRIPTION

In accordance with embodiments described herein, a store system comprises an image output section configured to output an image captured by an image capturing unit, an object recognition section configured to recognize a specific object by reading the characteristic quantity of the output image and a reporting section configured to report that an object other than a commodity subjected to sales registration is recognized in the condition that the recognized object is the object other than the commodity included in a commodity file storing information for the sales registration.

In accordance with embodiments described herein, a method comprises, recognizing a specific object by reading the characteristic quantity of an image captured by an image capturing unit and reporting that an object other than a commodity subjected to sales registration is recognized in the condition that the recognized object is the object other than the commodity included in a commodity file storing information for the sales registration.

Hereinafter, the store system and the program of the embodiment are described with reference to schemas by taking a settlement system for example. The store system is the settlement system (POS system) and the like comprising a POS terminal carrying out the registration and the check computation of the commodity in one deal. The present embodiment is an application example for the settlement system introduced into a store such as a supermarket, a western-style pastry store, a doughnut store and the like.

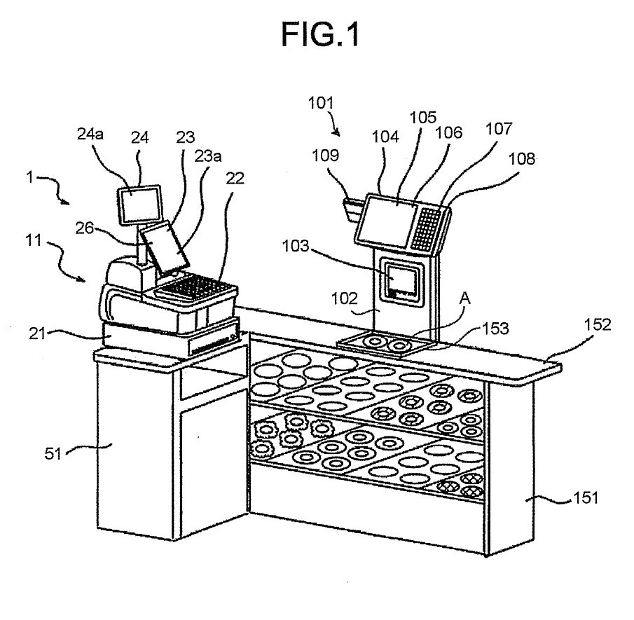

FIG. 1 is a perspective drawing showing the settlement system 1. As shown in FIG. 1, the settlement system 1 comprises the POS terminal 11 carrying out the registration and the check computation of the commodity in one deal. The POS terminal 11 is borne on the upper surface of a cash drawer 21 of a settlement platform 51. The opening action of the cash drawer 21 is controlled by the POS terminal 11. The upper surface of the POS terminal 11 is equipped with a keyboard 22 pressed down and operated by an operator (salesclerk). Observed from one side of the operator operating the keyboard 22, a display 23 displaying the information towards the operator is arranged at the more inner side of the keyboard 22. The display 23 displays the information on a display surface 23a. A touch panel 26 is laminated on the display surface 23a. A customer-oriented display 24 freely rotated is vertically arranged at the innermost side of the display 23. The customer-oriented display 24 displays the information on a display surface 24a. In addition, according to the customer-oriented display 24 shown in FIG. 1, the display surface 24a faces to an approximately front side in FIG. 1, the display surface 24a is enabled to face to an inner side in FIG. 1 by rotating the customer-oriented display 24, and the customer-oriented display 24 displays the information towards a customer.

An exhibition box 151 is configured in the way of forming an L character with the settlement platform 51 bearing the POS terminal 11. A goods receiving surface 152 is formed on the upper surface of the exhibition box 151. A tray 153 accepting a commodity A for carrying out the registration and the check computation is borne on the goods receiving surface 152.

A commodity reading apparatus 101 connected with the POS terminal 11 in the way of freely receiving and sending data is arranged on the goods receiving surface 152 of the exhibition box 151. The commodity reading apparatus 101 comprises a thin rectangular shell 102. A reading window 103 is configured on the front surface of the shell 102. A display/operating section 104 is mounted at the upper part of the shell 102. The display/operating section 104 is equipped with a display 106, on the surface of which a touch panel 105 is laminated. A keyboard 107 is arranged on the right side of the display 106. A card reading slot 108 of a card reader which is not shown in figures is arranged on the right side of the keyboard 107. Observed from one side of the operator, a customer-oriented display 109 for providing the information to the customer is arranged near the left inner side of the back surface of the display/operating section 104.

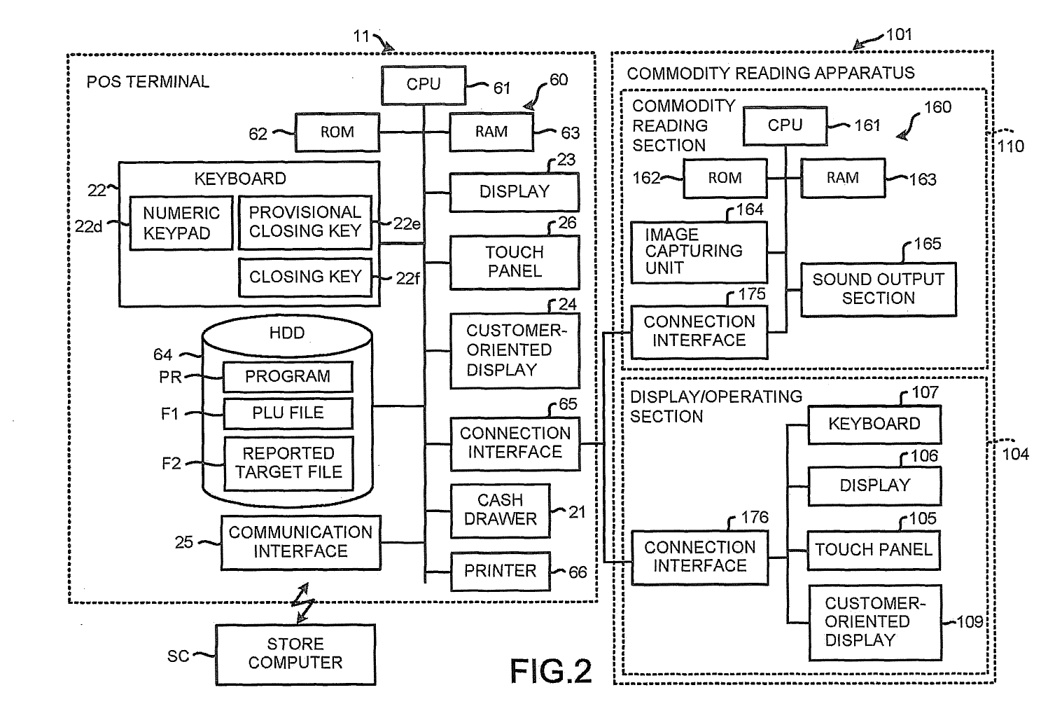

The commodity reading apparatus 101 comprises a commodity reading section 110 (referring to FIG. 2). The commodity reading section 110 is equipped with an image capturing unit 164 at the inner side of the reading window 103 (referring to FIG. 2).

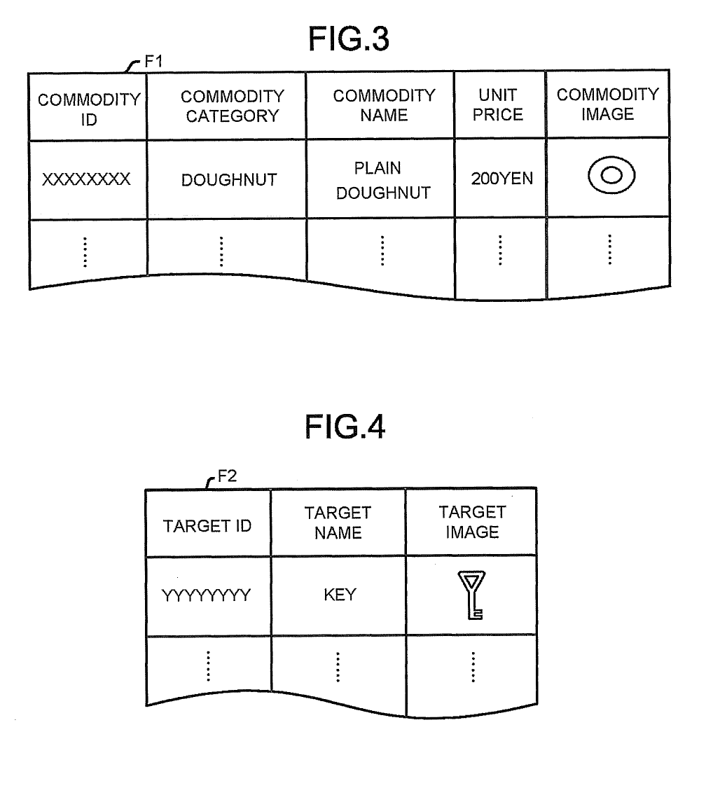

In the western-style pastry store, the doughnut store and the like, the customer selects the commodity A exhibited in the exhibition box 151, and the selected commodity A is put in the tray 153 by the customer or the salesclerk. Subsequently, the customer or the salesclerk carries the tray 153 accepting the commodity A by hands and bears the tray on the goods receiving surface 152. The tray 153 borne on the goods receiving surface 152 is enabled to face to the reading window 103 of the commodity reading apparatus 101. At this moment, the image capturing unit 164 (referring to FIG. 2) configured at the inner side of the reading window 103 shoots all the commodities A in the tray 153. In the commodity reading apparatus 101, all or part of the commodities A included in the image captured by the image capturing unit 164 are detected. In the commodity reading apparatus 101, in the condition that all or part of the commodities A included in the image captured by the image capturing unit 164 are detected, the captured image is output to the POS terminal 11. In the POS terminal 11, aiming at each commodity A, the commodity A as the specific object and the commodity A particularly subjected to the sales registration are recognized from all or part of the images of the commodities A shot by the image capturing unit 164 of the commodity reading section 110 with reference to a PLU file F1 (describing detailed contents hereinafter, referring to FIG. 3) establishing relevance for the information of the sales registration of the commodities A and the images of the commodities A, and the information of the sales registration such as the commodity ID, the commodity category, the commodity name, the unit price and the like of the specific commodity A is recorded in a sales master file (not shown in the figures) and the like to carry out the sales registration.

FIG. 2 is a block diagram showing hardware compositions of the POS terminal 11 and the commodity reading apparatus 101. The POS terminal 11 comprises a microcomputer 60 as an information processing section executing information processing. The microcomputer 60 is formed by connecting an ROM 62 (Read Only Memory) and an RAM 63 (Random Access Memory) onto a CPU 61 (Central Processing Unit) executing various calculation processing and further controlling all sections by buses.

The CPU 61 of the POS terminal 11 is connected with the cash drawer 21, the keyboard 22, the display 23, the touch panel 26 and the customer-oriented display 24 through various input and output circuits (all not shown in the figures). These members are controlled by the CPU 61.

The keyboard 22 includes a numeric keypad 22d, the upper surface of which displays numerals such as “1”, “2” , “3” . . . and the like and a multiplication operational character such as “x”, a provisional closing key 22e and a closing key 22f.

The CPU 61 of the POS terminal 11 is connected with an HDD 64 (Hard Disk Drive). The program and various files are stored in the HDD 64. All or part of the program and the various files stored in the HDD 64 are copied to the RAM 63 and are executed in sequence by the CPU 61 when the POS terminal 11 is started. One example of the program stored in the HDD 64 is a program PR for processing commodity sales data. One example of the files stored in the HDD 64 is the PLU file Fl and a reported target file F2 which are sent from a store computer SC and are stored.

The PLU file F1 is the file set to establish the relevance for the information of the sales registration of the commodity A and the image of the commodity A aiming at each commodity A exhibited and sold in the store. FIG. 3 is a conceptual graph exemplifying a data composition of the PLU file F1. As shown in FIG. 3, the PLU file F1 is the file which stores the information relevant with the commodity, such as the uniquely distributed commodity ID, the commodity category to which the commodity A belongs, the commodity name, the unit price and the like aiming at each commodity A and shoots the commodity image of the commodity.

The reported target file F2 is the file storing the information of a target reported as the object other than the commodity A subjected to the sales registration. The object other than the commodity A subjected to the sales registration is normally an article which is put in the tray 153 accepting the commodity A subjected to the registration and the check computation by mistake and is held by the customer or the salesclerk, and particularly comprises a key, a mobile phone, various cards and the like held by the customer and the salesclerk. The information such as the image, the name and the like of the target reported when the object is recognized is previously registered in the reported target file F2. FIG. 4 is a conceptual graph exemplifying a data composition of the reported target file F2. As shown in FIG. 4, the reported target file F2 stores a uniquely distributed target ID and a target name and shoots the target image of the target aiming at each object other than the commodity A subjected to the sales registration.

In FIG. 2, the CPU 61 of the POS terminal 11 is connected with the store computer SC and a communication interface 25 for executing data communication through the input and output circuits (not shown in the figures). The store computer Sc is arranged at a backyard and the like of the store. The PLU file F1 and the reported target file F2 which are sent to the POS terminal 11 are stored in the HDD (not shown in the figures) of the store computer SC.

In addition, the CPU 61 of the POS terminal 11 is connected with a connection interface 65 capable of receiving and sending the data with the commodity reading apparatus 101. The connection interface 65 is connected with the commodity reading apparatus 101. Moreover, the CPU 61 of the POS terminal 11 is connected with a printer 66 printing a receipt and the like. The POS terminal 11 prints the deal contents of one deal on the receipt based on the control of the CPU 61.

The commodity reading apparatus 101 further comprises a microcomputer 160. The microcomputer 160 is formed by connecting an ROM 162 and an RAM 163 onto a CPU 161 by buses. The program executed by the CPU 161 is stored in the ROM 162. The CPU 161 is connected with the image capturing unit 164 and a sound output section 165 through various input and output circuits (all not shown in the figures). The actions of the image capturing unit 164 and the sound output section 165 are controlled by the CPU 161. The display/operating section 104 is connected onto the POS terminal 11 through a connection interface 176. The action of the display/operating section 104 is controlled by the CPU 61 of the POS terminal 11.

The image capturing unit 164 is a camera CCD image sensor or a camera COMS image sensor and the like, and is the carrying out capturing from the reading window 103 under the control of the CPU 161. For instance, the image capturing unit 164 carries out the capturing of a 30fps of dynamic image. The image capturing unit 164 stores frame images which are captured in sequence according to a specified frame rate in the RAM 163.

The sound output section 165 is a sound circuit, a loudspeaker and the like for generating a preset warning tone and the like. The sound output section 165 carries out reporting by sounds such as the warning tone and the like under the control of the CPU 161.

In addition, the CPU 161 is connected with a connection interface 175, and the connection interface 175 is connected with the connection interface 65 of the POS terminal 11 and can receive and send the data with the POS terminal 11. Under the control of the CPU 161, the images (including all or part of the images of the commodities A) captured by the image capturing unit 164 of the commodity reading apparatus 101 are output through the connection interface 175 and are further input to the POS terminal 11 through the connection interface 65.

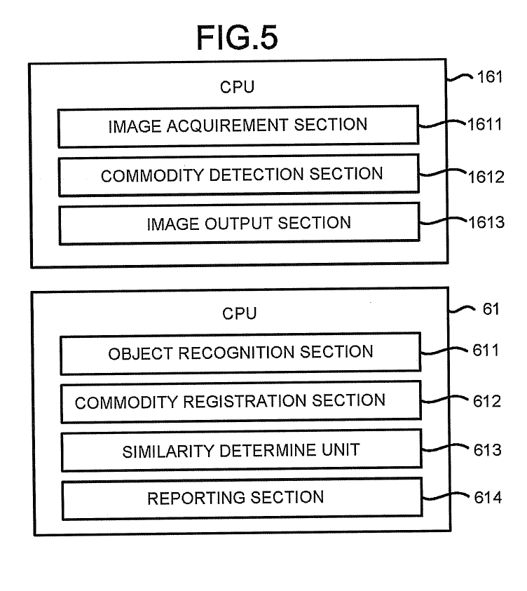

Next, functional sections of the CPU 161 and the CPU 61 realized by executing the program by the CPU 161 and the CPU 61 in sequence are described with reference to FIG. 5. FIG. 5 is a block diagram showing function compositions of the CPU 161 and the CPU 61. As shown in FIG. 5, the CPU 161 exerts the functions as an image acquirement section 1611, a commodity detection section 1612, and the image output section, namely an image output section 1613 by executing the program in sequence. Similarly, the CPU 61 exerts the functions as the object recognition section, namely an object recognition section 611, a commodity registration section 612, a similarity calculating section, namely a similarity determine unit 613, and the reporting section, namely a reporting section 614.

The image acquirement section 1611 outputs a capturing -on signal to the image capturing unit 164, so that the image capturing unit 164 begins an image capturing unit. The image acquirement section 1611 acquires the frame images stored in the RAN 163 after being captured by the image capturing unit 164 in sequence after the capturing action begins. The image acquirement section 1611 acquires the frame images according to a storage sequence in the RAM 163.

The commodity detection section 1612 detects all or part of the articles such as the commodities A and the like included in the frame images acquired by the image acquirement section 1611 by utilizing a pattern matching technique and the like. Particularly, contour lines and the like are extracted from the images obtained by carrying out binaryzation on the acquired frame images. Subsequently, the contour line extracted from the nearest frame image is compared with that extracted from the present frame image to detect a part with alteration, namely the mapping into of the articles including the commodities A which face to the reading window 103 for carrying out the sales registration. In addition, as other methods for detecting the articles including the commodities A, the existence of a skin color region is detected according to the obtained frame images. Subsequently, in the condition that the skin color region is detected, namely in the condition that the mapping into of the hands of the salesclerk and the like is detected, the contour of a component including the commodity A supposed to be held by the hands of the salesclerk and the like is tentatively extracted by detecting the contour line . At this moment, in the condition that the contour showing a hand shape and other contours are detected, as the salesclerk holds the commodity by hands, the mapping into of the articles including the commodities A is detected.

The image output section 1613 outputs the frame images acquired by the image acquirement section 1611 to the POS terminal 11 through the connection interface 175. The image output section 1613 further can output the frame images acquired by the image acquirement section 1611 to the POS terminal 11 successively, and in the present embodiment, all or part of the frame images of the articles such as the commodities A and the like detected by the commodity detection section 1612 are output to the POS terminal 11. As described above, all or part of the frame images of the articles such as the commodities A and the like detected by the commodity detection section 1612 are output to the POS terminal 11, so that the condition that the POS terminal 11 executes object recognition according to all or part of the frame images of the articles excluding the commodities A and the like and with reference to the PLU file F1 can be prevented. As the recognition processing of the specific object needs processing time, the processing time can be shortened by preventing the recognition probability without the specific object and the processing of all or part of the frame images excluding the commodities A.

The object recognition section 611 reads surface states such as hue, surface concave-convex status and the like as the characteristic quantities according to all or part of the images of the articles included in the images captured by the image capturing unit 164 of the commodity reading apparatus 101 and with reference to the commodity image in the PLU file F1 and the target image in the reported target file F2, and recognizes the commodity A as the specific object or recognizes a reported target as the object other than the commodity A. In addition, in order to shorten the processing time, the object recognition section 611 does not consider the contours and the sizes of the commodity A and the target reported as the object other than the commodity A. In the POS terminal 11, the commodity A read by the commodity reading apparatus 101 can be specified from the commodities previously registered in the PLU file F1 according to the recognition result of the object recognition section 611.

The similarity determine unit 613 as the, similarity calculating section calculates out the similarity representing the similarity degree of the commodity A recognized by the object recognition section 611 and the commodity image in the PLU file F1, and judges whether or not the calculated similarity exceeds a preset threshold value. The similarity is calculated based on the consistency degree of each image by reading out a region corresponding to the commodity A in the frame image recognized by the object recognition section 611 and including the commodity A and comparing the read-out region with the commodity image of the commodity specified by the PLU file F1 for correspondingly recognizing the commodity A.

The method for recognizing the object included in the image is normally called as generic object recognition. About the generic object recognition, various recognition techniques are explicated in the following document.

Yanai Keiji, “present state and perspectives of generic object recognition”, collected papers of information processing society, Vol. 48, No. SIG16 [retrieved on Heisei Aug. 10, 22], Internet <URL:http://mm.cs.uec.ac.jp/IPSJ-TCVIM-Yanai.pdf>.

Moreover, the technique for the generic object recognition by carrying out region segmentation on the image according to a target is explicated in the following document.

Jamie Shotton and the like, “Semantic Texton Forests for Image Categorization and Segmentation”, [retrieved on Heisei Aug. 10, 22], Internet <URL:http://citeseerx.ist.psu.edu/viewdoc/download?doi=10.1.1.145.3036&rep=rep1&type=pdf>.

The commodity registration section 612 records the information of the sales registration relevant with the commodity image recognized by the object recognition section 611, namely the commodity ID, the commodity category, the commodity name, the unit price and the like of the commodity specified as the commodity A read by the commodity reading apparatus 101 in the sales master file and the like, so as to carry out the sales registration.

In the condition that the object recognized by the object recognition section 611 is the object other than the commodity included in the PLAY file F1, the reporting section 614 reports the content that the object other than the commodity subjected to the sales registration is recognized by the warning tone output of the sound output section 165, the display on display pictures of the display 23 and the customer-oriented display 24 and the like (detailed contents are described hereinafter.).

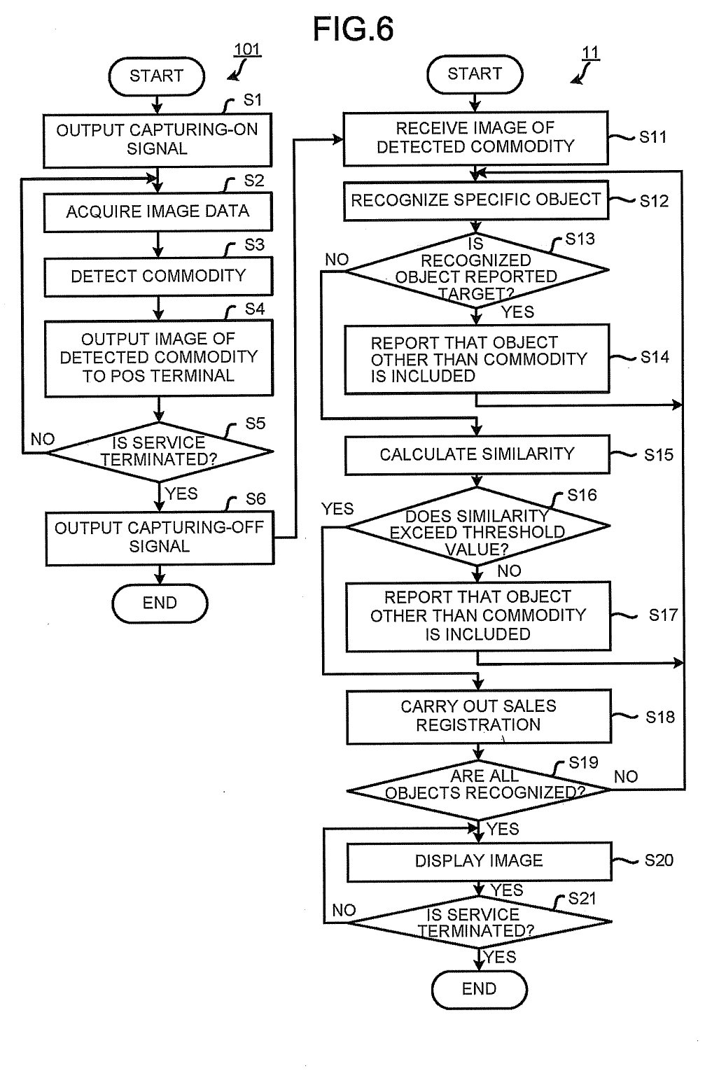

Next, the action of the settlement system 1 is described in detail. FIG. 6 is a flow chart showing an example of the processing actions of the settlement system 1 of the embodiment.

First, the action on the side of the commodity reading apparatus 101 is described. As shown in FIG. 6, when the POS terminal 11 begins carrying out the processing corresponding to the beginning of commodity registration and the like, the image acquirement section 1611 outputs the capturing -on signal to the image capturing unit 164, so that the image capturing unit 164 begins capturing (S1). Subsequently, the image acquirement section 1611 acquires the frame images (captured images) stored in the RAM 163 after being captured by the image capturing unit 164 (S2). Subsequently, the commodity detection section 1612 detects all or part of all the commodities A in the tray 153 according to the frame images acquired by the image acquirement section 1611 (S3). Subsequently, the image output section 1613 outputs all or part of the frame images of all the commodities A in the tray 153, which are detected by the commodity detection section 1612 to the POS terminal (S4).

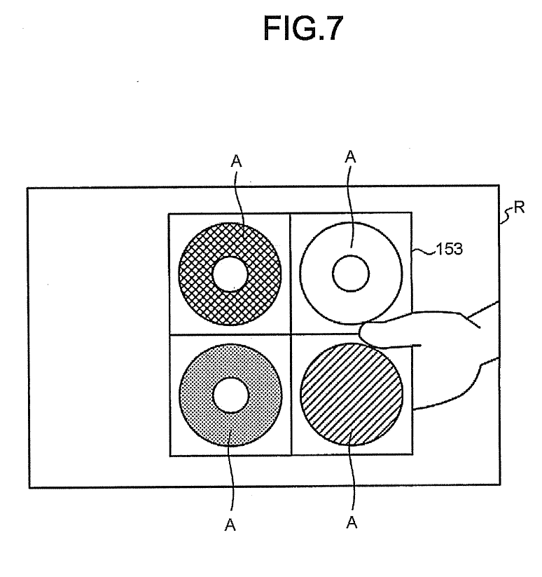

FIG. 7 is a conceptual graph showing an example of a reading region R of the reading window 103. Particularly, FIG. 7 is the conceptual graph exemplifying the reading region R when the commodity A is read. As shown in FIG. 7, in the condition that the commodity A in the tray 153 borne on the goods receiving surface 152 is mapped in the reading region R, all or part of all the commodities A in the tray 153 are detected in S3 according to the frame images obtained by capturing the reading region R. By detecting all or part of all the commodities A in the tray 153, the frame images obtained by capturing the reading region R are output to the POS terminal 11 in S4.

Subsequently, the CPU 161 judges whether or not the POS terminal 11 gives a commodity registration termination notice and the like to terminate a service (S5). In the condition of continuing the service (S5: No), the CPU 161 returns the processing to S2 and continuously carries out the processing. In the condition of terminating the service (S5: Yes), the image acquirement section 1611 outputs a capturing -off signal to the image capturing unit 164, terminates the capturing of the image capturing unit 164 (S6), and terminates the processing.

Next, the actions on the side of the POS terminal 11 are described. As shown in FIG. 6, if the processing begins according to the beginning of the commodity registration and the like brought about by the operation indication of the keyboard 22, the CPU 61 receives all or part of the frame images output from the commodity reading apparatus 101 and detecting all the commodities A in the tray 153 (S11). Subsequently, the object recognition section 611 sequentially recognizes the commodities A as the specific objects or recognizes the target reported as the object other than the commodities A with reference to the commodity image in the PLU file F1 and the target image in the reported target file F2 and according to all or part of the images of all the commodities A in the tray 153, which are output by the commodity reading .apparatus 101 (S12).

Subsequently, the CPU 61 judges whether or not the object recognized in S12 is the reported target specified by the target image in the reported target file F2 (S13). In the condition that the object recognized in S12 is the reported target (S13: Yes), the reporting section 614 reports the content that the object (reported target) other than the commodity A is included by the warning tone output of the sound output section 165, the display on the display pictures of the display 23 and the customer-oriented display 24 and the like (S14).

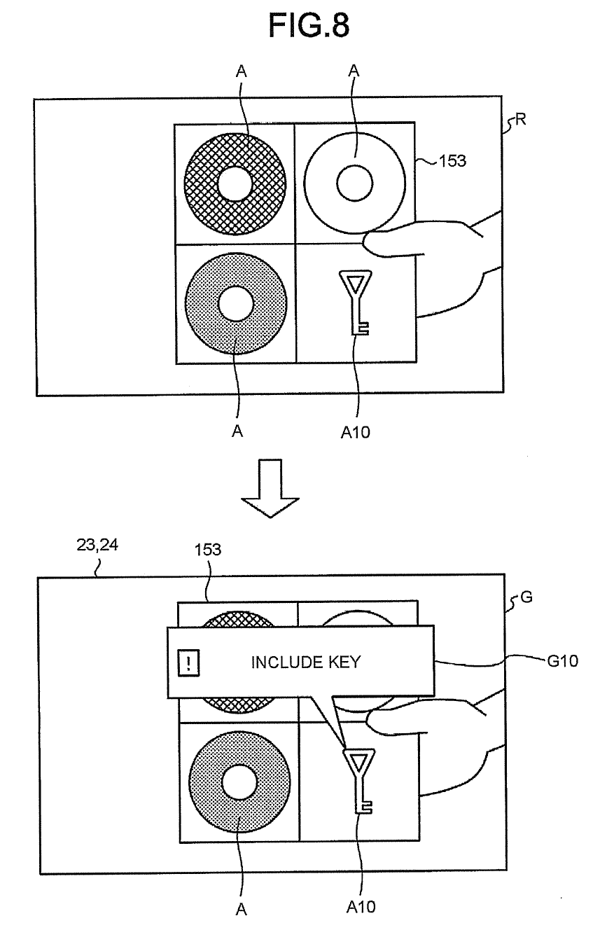

FIG. 8 is a conceptual graph exemplifying a condition that the object other than the commodity A is recognized. As shown in FIG. 8, in the tray 153 borne on the goods receiving surface 152, besides the commodity A, the reported target A10 (the key in a graphic example) such as the article and the like held by the customer and the salesclerk exists. In the condition that the reported target A10 is mapped into the reading region R, the target reported as the object other than the commodity A in the reported target A10 is recognized in S12 according to the frame images obtained by capturing the reading region R. By the recognition of the reported target A10, in S14, a report image G10 representing that the reported target A10 is included in the tray 153 as the object other than the commodity A is displayed on the display pictures of the display 23 and the customer-oriented display 24. Particularly, the report image G10 is displayed at a position corresponding to the reported target A10 in the frame image in which the reported target A10 is detected. The report image G10 is displayed by reading out the target name corresponding to the reported target A10 from the PLU file F1. By the report, the customer and the salesclerk can distinguish that the reported target other than the commodity A subjected to the registration and the check computation, which is registered in the reported target file F2, is put in the tray 153 in the settlement system.

In the condition that the object recognized in S12 is not the reported target (S13: No), namely, in the condition that the object recognized in 512 is the commodity A, the similarity determine unit 613 calculates the similarity representing the similarity degree of the recognized commodity A and the commodity image in the PLU file F1 (S15). Subsequently, the CPU 61 judges whether or not the similarity calculated in S15 exceeds the preset threshold value (S16)

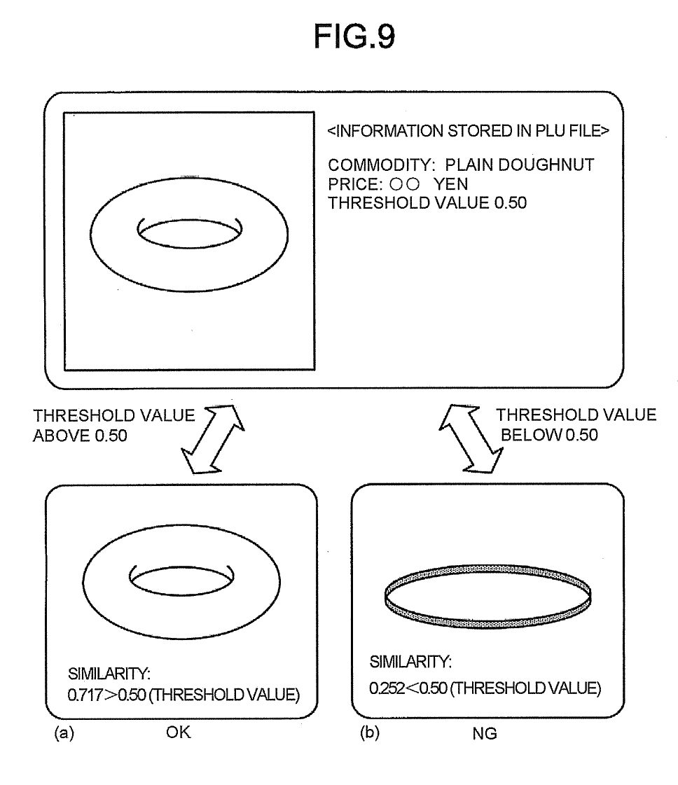

FIG. 9 is an explanatory drawing schematically showing an embodiment of the processing, and more particularly, is the explanatory drawing showing a judgment example in S16. As shown in FIG. 9, in the condition that the commodity A recognized by the object recognition section 611 is a “plain doughnut”, whether or not the similarity of the commodity image of the “plain doughnut” stored in the PLU file Fl and the captured image exceeds the preset threshold value (0.50) is judged. In the condition of (a), as the commodity A is the general “plain doughnut”, the calculated similarity is 0.717 and exceeds the threshold value (0.50). In the condition of (b), the commodity A is a rubber belt and the like similar with the “plain doughnut” in color and shape, therefore, the calculated similarity is 0.252 and is lower than the threshold value (0.50).

In the condition that the similarity exceeds the preset threshold value (S16: No), the reporting section 614 reports the content that the object (not registered in the reported target file F2 as the reported target) other than the commodity A is included by the warning tone output of the sound output section 165, the display on the display pictures of the display 23 and the customer-oriented display 24 and the like (S17).

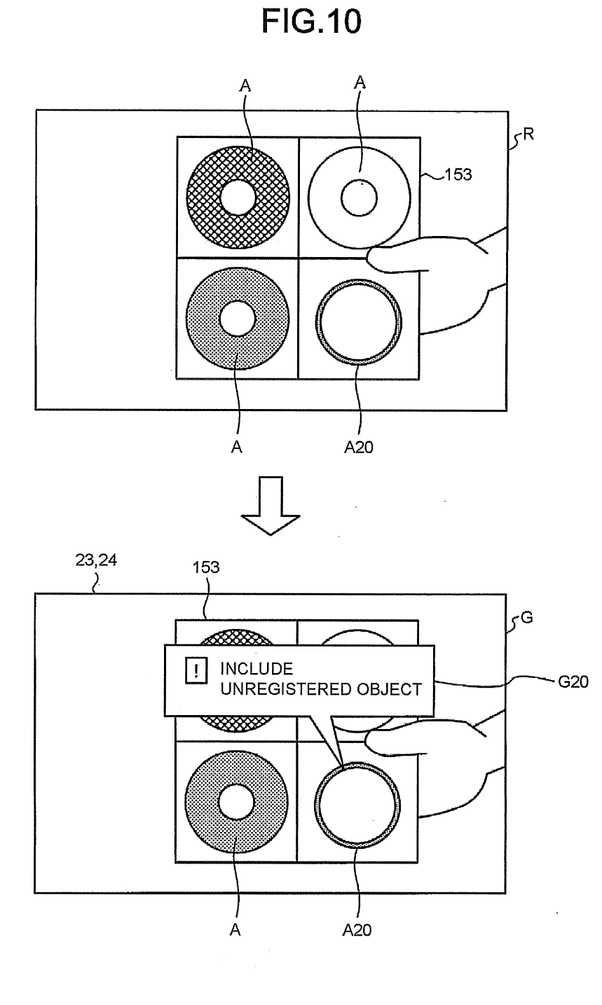

FIG. 10 is a conceptual graph exemplifying the condition that the object other than the commodity A is recognized. As shown in FIG. 10, in the tray 153 borne on the goods receiving surface 152, besides the commodity A, an object A20 (the rubber belt in the graphic example) which is similar with the commodity image registered in the PLU file F1 in shape although not being registered in the reported target file F2 further exists. In the condition that the object A20 is mapped into the reading region R, in S16, as the similarity is lower than the set threshold value, the commodity A is recognized as the object other than the commodity A. In S17, a report image G20 representing that the object A20 other than the commodity A, which is not registered in the PLU file F1 and the reported target file F2 is included in the tray 153 is displayed on the display pictures G of the display 23 and the customer-oriented display 24. Particularly, the report image G20 is displayed at a position corresponding to the object A20 in the frame image in which the object A20 is detected. By the report, the customer and the salesclerk can distinguish that the article (not registered in the reported target file F2) other than the commodity A subjected to the registration and the check computation is put in the tray 153 in the settlement system 1.

In the condition that the similarity exceeds the preset threshold value (S16: Yes), the commodity registration section 612 carries out the sales registration on the recognized commodity A (S18). Subsequently, the CPU 61 judges whether or not all the objects are recognized (S19). In the condition that the CPU 61 judges that all the objects are recognized (S19: Yes), the processing enters S20, and in the condition that the CPU 61 judges that not all the objects are recognized (S19: No), the processing is returned to S12 to continue the recognition processing of the next object.

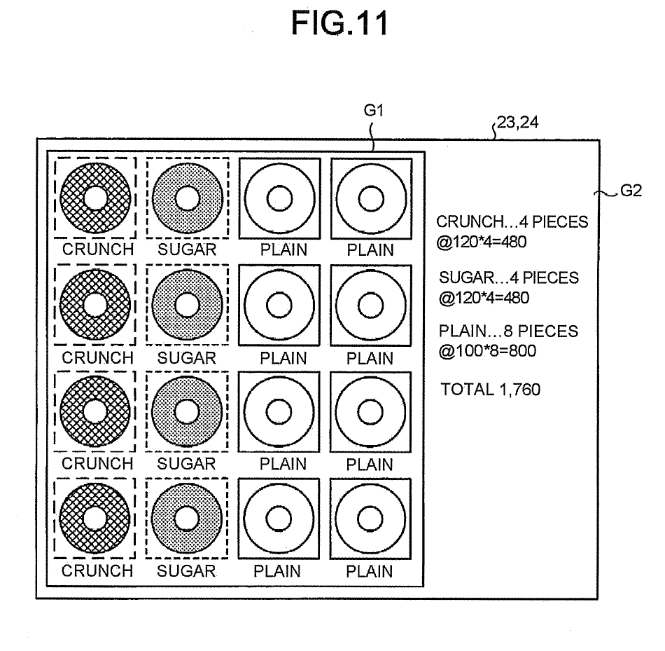

In S20, the CPU 61 enables the salesclerk and the customer to confirm to purchase the commodity by the picture display of the display 23 and the customer-oriented display 24 shown in FIG. 11. In the example shown in FIG. 11, the image of the tray 153 storing the commodity A is displayed in a display region G1, and furthermore, the previously stored commodity information such as the commodity name, the unit price and the like of the commodity A and the records of the purchased commodity such as quantity, total amount and the like are displayed together in a display region G2. Moreover, the commodity name is further added on the commodity image of the commodity A displayed in the display region G1. The display of the records of the purchased commodity in the display region G2 is carried out by the CPU 61 of the POS terminal 11 based on the information of the purchased commodity stacked in the RAM 63. By the picture display, the customer can confirm whether or not there is difference with the required commodity.

Subsequently, the CPU 61 judges whether or not there is the operation of the keyboard 22 indicating sales registration termination and the like to terminate the service (S21). In the condition that the service is terminated (S21: Yes), the CPU 61 terminates the picture display of the display 23 and the customer-oriented display 24, and terminates the processing.

As described above, in the settlement system 1 of the embodiment, the specific object is recognized by reading the characteristic quantity of the image output from the commodity reading apparatus 101, and in the condition that the recognized object is the object other than the commodity A included in the PLU file F1 storing the information for the sales registration, the reporting section 614 reports that the object other than the commodity A subjected to the sales registration is recognized. Therefore, in the settlement system 1, the customer and the salesclerk can distinguish, for example, the article other than the commodity A subjected to the sales registration is put in the tray 153 taken to the settlement system 1.

The program executed by the POS terminal 11 and the commodity reading apparatus 101 of the present embodiment is provided by being previously programmed in the ROM and the like. The program executed by the POS terminal 11 and the commodity reading apparatus 101 of the embodiment further can be constituted to be provided by recording the file in an installable way or executable way in a computer-readable recording medium such as a CD-ROM, a floppy disk (FD) , a CD-R, a DVD (Digital Versatile Disk) and the like.

In addition, the program executed by the POS terminal 11 and the commodity reading apparatus 101 of the embodiment further can be constituted to be stored in the computer connected with a network such as the Internet and the like and is provided after being downloaded by the network. Moreover, the program executed by the POS terminal 11 and the commodity reading apparatus 101 of the present embodiment further can be constituted to be provided or issued by the network such as the Internet and the like.

The program executed by the POS terminal 11 of the present embodiment consists of modules including all the function compositions, and as actual hardware, the CPU (processor) loads all the function compositions on a main storage apparatus by reading out the program from the ROM and executing the program, and generates all the function compositions on the main storage apparatus.

The program executed by the commodity reading apparatus 101 of the present embodiment consists of the modules including all the function compositions, and as the actual hardware, the CPU (processor) loads all the function compositions on the main storage apparatus by reading out the program from the ROM and executing the program, and generates all the function compositions on the main storage apparatus.

In addition, the side of the POS terminal 11 of the present embodiment comprises the object recognition section 611, the commodity registration section 612, the similarity determine unit 613 and the reporting section 614, but not limited to this, the side of the commodity reading apparatus 10 further can comprise the object recognition section 611, the commodity registration section 612, the similarity determine unit 613 and the reporting section 614. In this case, the commodity reading apparatus 101 is the store system.

Moreover, in the present embodiment, the side of the commodity reading apparatus 101 comprises the image acquirement section 1611, the commodity detection section 1612 and the image output section 1613, but not limited to this, the side of the POS terminal 11 further can comprise the image acquirement section 1611, the commodity detection section 1612 and the image output section 1613. In this case, the POS terminal 11 is the store system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A store system, comprising:
an image output section configured to output an image captured by an image capturing unit;
an object recognition section configured to recognize a specific object by reading the characteristic quantity of the output image; and
a reporting section configured to report that an object other than a commodity subjected to sales registration is recognized in the condition that the recognized object is the object other than the commodity included in a commodity file storing information for the sales registration.

2. The store system according to claim 1, wherein
the reporting section reports that the object other than the commodity subjected to the sales registration is recognized in the condition that the recognized object is included in a reported target file storing the information as the object other than the commodity subjected to the sales registration.

3. The store system according to claim 1, further comprising:
a similarity calculating section configured to calculate the similarity of the image corresponding to the recognized object in the output image and the image of the commodity included in the commodity file, wherein
the reporting section reports that the object other than the commodity subjected to the sales registration is recognized in the condition that the calculated similarity is lower than a specified value.

4. The store system according to claim 2, further comprising:
a similarity calculating section configured to calculate the similarity of the image corresponding to the recognized object in the output image and the image of the commodity included in the commodity file, wherein
the reporting section reports that the object other than the commodity subjected to the sales registration is recognized in the condition that the calculated similarity is lower than a specified value.

5. A method, comprising:
recognizing a specific object by reading the characteristic quantity of an image captured by an image capturing unit; and
reporting that an object other than a commodity subjected to sales registration is recognized in the condition that the recognized object is the object other than the commodity included in a commodity file storing information for the sales registration.

6. The method according to claim 5, wherein
the reporting that the object other than the commodity subjected to the sales registration is recognized in the condition that the recognized object is included in a reported target file storing the information as the object other than the commodity subjected to the sales registration.

7. The method according to claim 5, further
calculating the similarity of the image corresponding to the recognized object in the output image and the image of the commodity included in the commodity file; and
reporting that the object other than the commodity subjected to the sales registration is recognized in the condition that the calculated similarity is lower than a specified value.

8. The method according to claim 6, further
calculating the similarity of the image corresponding to the recognized object in the output image and the image of the commodity included in the commodity file; and
reporting that the object other than the commodity subjected to the sales registration is recognized in the condition that the calculated similarity is lower than a specified value.
